(19) United States
(12) Patent Application Publication
(10) Pub. No.: US 2013/0201487 A1
(43) Pub. Date: Aug. 8, 2013

(54) DEVICE FOR OPTICALLY SCANNING AND MEASURING AN ENVIRONMENT

(71) Applicants: Martin Ossig, Tamm (DE); Benjamin Lutz, Pfinztal (DE)

(72) Inventors: Martin Ossig, Tamm (DE); Benjamin Lutz, Pfinztal (DE)

(73) Assignee: FARO TECHNOLOGIES, INC., Lake Mary, FL (US)

(21) Appl. No.: 13/812,235

(22) PCT Filed: Jul. 1, 2011
(86) PCT No.: PCT/EP2011/003262

§ 371 Date: Apr. 5, 2013

Related U.S. Application Data
(60) Provisional application No. 61/380,414, filed on Sep. 7, 2010.

(30) Foreign Application Priority Data
Jul. 26, 2010 (DE) 10 2010 032 724.7

(51) Int. Cl. G01B 11/24

(52) U.S. Cl. CPC G01B 11/24
USPC 356/601

(57) ABSTRACT

A device for optically scanning and measuring an environment is designed as a laser scanner having a light emitter that emits an emission light beam and a light receiver that receives a reception light beam which is reflected from an object in the environment of the laser scanner. The laser scanner also includes a control and evaluation unit which, for a multitude of measuring points, determines at least the distance to the object. The spot of the emission light beam temporarily moves along a prism of the laser scanner, the prism having at least two different brightness levels and/or colors.

### CROSS REFERENCE TO RELATED APPLICATIONS

The present application is a National Stage Application of PCT Patent Application No. PCT/EP2011/003262, filed on Jul. 1, 2011, which claims the benefit of U.S. Provisional Patent Application No. 61/380,414, filed on Sep. 7, 2010, and of pending German Patent Application No. DE 10 2010 032 724.7, filed on Jul. 26, 2010, and which are hereby incorporated by reference.

### BACKGROUND OF THE INVENTION

The invention relates to a device for optically scanning and measuring an environment.

By a device such as is known for example from U.S. Published Patent Application No. 2010/0134596, and which comprises a laser scanner, the environment of the laser scanner can be optically scanned and measured.

### SUMMARY OF THE INVENTION

Embodiments of the present invention are based on the object of improving a device of the type mentioned hereinabove.

The components of the laser scanner are arranged in two parts of the measuring head and in a traverse of the carrying structure which connects the two parts. To reduce the weight of the laser scanner, a shell is provided as part of the housing, for example one shell for each of the two parts of the measuring head, wherein the shell can be made of a relatively light weight material, for example a plastic material, and covers the corresponding components of the laser scanner to protect them. To protect the shell, a yoke is provided, for example one yoke for each of the shells, which partially covers the outside of the shell and which can be made of a light weight material, for example aluminum.

The carrying structure, which, for weight purposes, can be made of aluminum, may have walls which serve for fixing the components with the optics and the rotating mirror. The walls can also close the semi-open shells. The yoke may extend along the outer edges and/or diagonally over the outer surfaces of the shell and is fixed to the carrying structure, for example at its ends, and also in its center at one of the two walls. In addition to the protective function, additional functions can be integrated into the yoke.

The parameters of the laser scanner, particularly temperature, can change during operation. As such, comparative measuring is necessary for a correction. It is suggested to move the spot of the emission light beam temporarily along a prism which has a known geometry and a known distance to the center of the laser scanner. The prism additionally has at least two different brightness levels and/or colors, to generate different signal levels of the reception light beam. The different brightness levels and/or colors may alternate along the direction of motion of the spot of the emission light beam.

During the rotation of the mirror, the emission light beam is projected onto the traverse of the carrying structure once during every mirror rotation, which results in the environment below the traverse of the carrying structure not being able to be measured by the laser scanner. The prism therefore is configured at the traverse of the carrying structure. A particular geometrical shape, perpendicular to the direction of motion of the spot of the emission light beam, or in the direction of motion, can take account of the imaging properties of the receiving optics and thus control the resulting signal quality. Through use of the different brightness levels and/or colors and the known distance of the prism from the center of the laser scanner, the control and evaluation unit of the laser scanner carries out a correction of the distance correction.

For assembling the laser scanner the components have mechanical and electrical interfaces. Particularly between the parts which are rotatable relative to one another, a relatively high precision is required. The laser scanner therefore is provided with a swivel-axis module which, as a pre-assembled assembly, is provided with the base resting in the stationary reference system of the laser scanner and with parts which can be fixed to the carrying structure of the measuring head which is rotatable relative to the base. The interfaces, which are rotatable relative to one another, are then displaced into the interior of the interface module. The interfaces between the swivel-axis module and the further parts of the measuring head can be configured relatively more simply such that, when inserting the swivel-axis module, for example into a receiving slot of the carrying structure, the interfaces are closed in the direction of insertion.

In the laser scanner, the motors for rotating the measuring head and the mirror, as well as the control and evaluation unit and the further electronic components, generate heat which must be removed. For this purpose, the laser scanner is provided with an integrated cooling device, based on a ventilation. Hereby, the air is led by an air inlet into a space between the carrying structure and the shell, serving as a housing, from where it passes through a suction duct, which is sealed with respect to the interior of the carrying structure, into the interior of the cooling device. From there, a fan blows the heated-up air through a further outlet duct, which is sealed with respect to the interior of the carrying structure, and through an air outlet to the outside. The heat can thus be removed without impairing the tightness of the central components. One filter each at the air inlet and the air outlet avoids intrusion of dust and coarse dust particles into the spaces and ducts of the cooling device. The air inlet and the air outlet are orientated, for example by ribs, in that the air streams point away from each other, i.e., unintersectedly into directions which are spread apart. The suction duct and the outlet duct, which have for example a rectangular profile, are connected to the housing of the fan in a sealed manner. Additionally, if required, the ducts can be completely sealed by suitable plugs. Each of the two shells is semi-open and closed by a wall of the carrying structure, the air inlet and the air outlet meeting exactly one of the two shells, sealed with respect to one another and with respect to the space. A sealing of the shells, which are arranged outside, against the carrying structure thus guarantees a complete sealing of the laser scanner. In addition to this ventilation, the cooling device may be provided with passive cooling elements, for example cooling fins and/or heat pipes, to transfer heat from sections of the interior of the carrying structure to the active cooling elements. This can be the heat from the electronics or, if the carrying structure is subdivided into two halves which are sealed with respect to one another, the heat from the other half without active cooling elements of the carrying structure.

### BRIEF DESCRIPTION OF THE DRAWINGS

The invention is explained in more detail below on the basis of an exemplary embodiment illustrated in the drawing, in which:

FIG. 1 is a perspective illustration of the laser scanner;

FIG. 2 is a slightly perspective lateral view of the laser scanner;

FIG. 3 is a bottom view of the laser scanner;

FIG. 4 is a section of the laser scanner in the zone of the swivel-axis module;

FIG. 5 is a perspective partial view of the laser scanner without a shell;

FIG. 6 is a partial view of the cooling device with the perspective of FIG. 5; and

FIG. 7 is a schematic illustration of the laser scanner during operation.

### DETAILED DESCRIPTION OF THE INVENTION

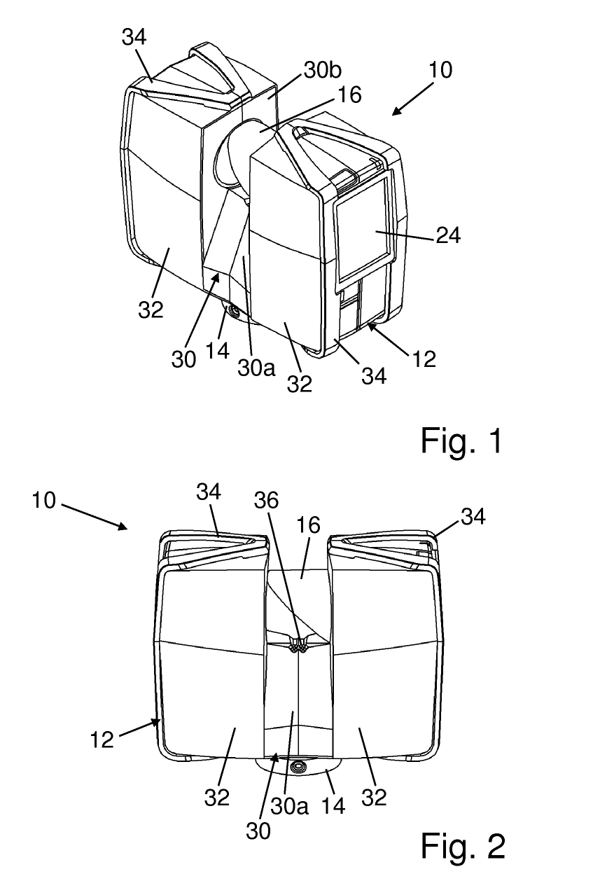

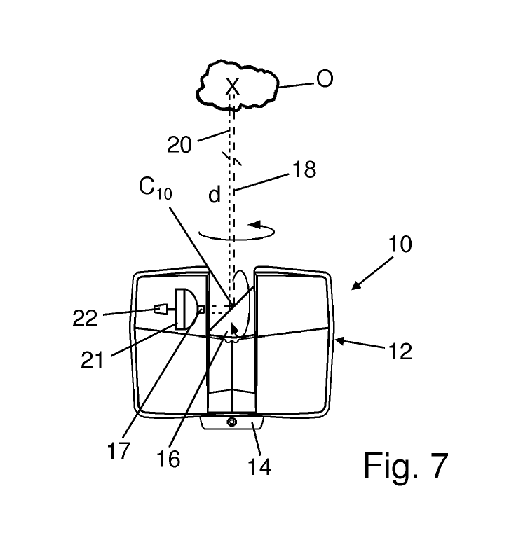

Referring to FIGS. 1, 2, and 7, a laser scanner 10 is provided as a device for optically scanning and measuring the environment of the laser scanner 10. The laser scanner 10 has a measuring head 12 and a base 14. The measuring head 12 is mounted on the base 14 as a unit that can be rotated about a vertical axis. The measuring head 12 has a rotary mirror 16, which can be rotated about a horizontal axis. The intersection point of the two rotational axes is designated the center C₁₀ of the laser scanner 10.

The measuring head 12 is further provided with a light emitter 17 for emitting an emission light beam 18. The emission light beam 18 may be a laser beam in the range of approximately 300 to 1600 nm wave length; for example 790 nm, 905 nm or less than 400 nm. Also other electro-magnetic waves having, for example, a greater wave length can be used. The emission light beam 18 is amplitude-modulated, for example with a sinusoidal or with a rectangular-waveform modulation signal. The emission light beam 18 is emitted by the light emitter 17 onto the rotary mirror 16, where it is deflected and emitted to the environment. A reception light beam 20, which is reflected in the environment by an object O or scattered otherwise, is captured again by the rotary mirror 16, deflected and directed onto a light receiver 21. The direction of the emission light beam 18 and of the reception light beam 20 results from the angular positions of the rotary mirror 16 and the measuring head 12, which depend on the positions of their corresponding rotary drives which, in turn, are registered by one encoder each.

A control and evaluation unit 22 has a data connection to the light emitter 17 and to the light receiver 21 in the measuring head 12, whereby parts of the unit 22 can be arranged also outside the measuring head 12, for example a computer connected to the base 14. The control and evaluation unit 22 determines, for a multitude of measuring points X, the distance d between the laser scanner 10 and the illuminated point at object O, from the propagation time of the emission light beam 18 and the reception light beam 20. For this purpose, the phase shift between the two light beams 18 and 20 can, for example, be determined and evaluated.

Scanning takes place along a circle by means of the relatively quick rotation of the rotary mirror 16. By virtue of the relatively slow rotation of the measuring head 12 relative to the base 14, the whole space is scanned step by step, by the circles. The entity of measuring points X of such a measurement is designated as a scan. For such a scan, the center C₁₀ of the laser scanner 10 defines the origin of the local stationary reference system. The base 14 rests in this local stationary reference system.

In addition to the distance d to the center C₁₀ of the laser scanner 10, each measuring point X comprises a brightness information value which is determined by the control and evaluation unit 22. The brightness value is a gray-tone value which is determined, for example, by integration of the bandpass-filtered and amplified signal of the light receiver 21 over a measuring period which is attributed to the measuring point X. A color camera can optionally generate pictures through which colors (R,G,B) can be assigned to the measuring points as values.

A display device 24 is connected to the control and evaluation unit 22. The display device 24 is integrated into the laser scanner 10, for example into the measuring head 12. The display device 24 shows a preview of the scan.

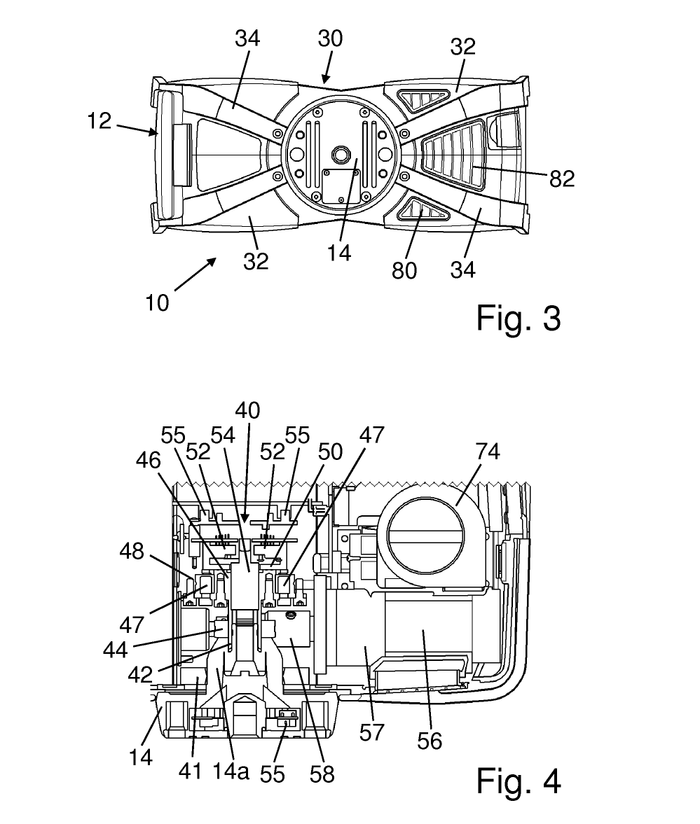

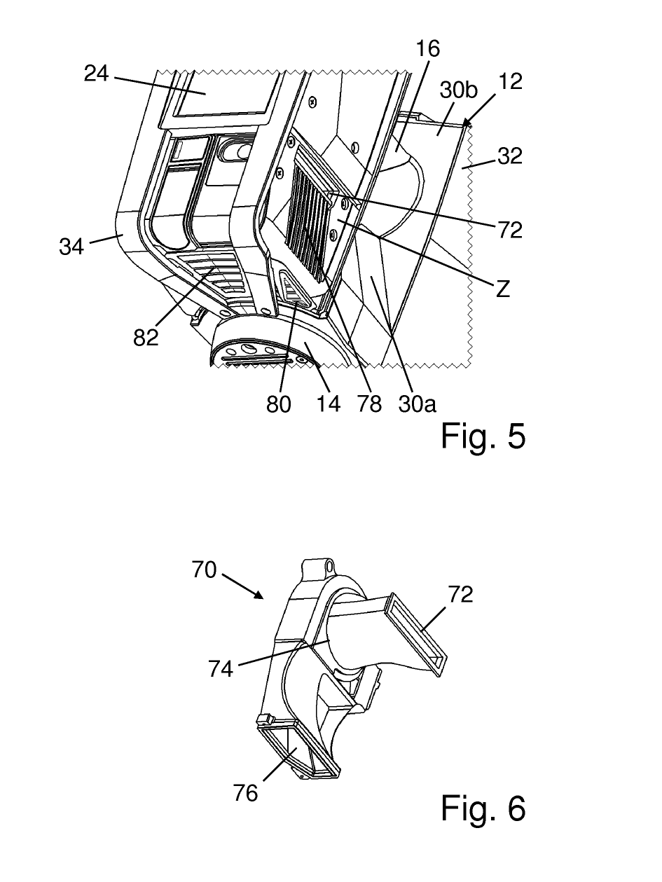

Referring also to FIGS. 3-6, the laser scanner 10 has a carrying structure 30 which serves as skeleton of the measuring head 12 and at which different components of the laser scanner 10 are fixed. In an embodiment, the carrying structure 30 is made of aluminum and in one piece. Above the base 14, the carrying structure 30 has a traverse 30a which is visible from the outside and which, at both ends, carries two walls 30b, which are parallel to one another and project upwards from the traverse 30a. Two shells 32 are configured as a housing which is open to one side, and which may be made of plastic. Each of the two shells 32 covers part of the components of the laser scanner 10 which are fixed to the carrying structure 30 and is assigned to one of the two walls 30b, to which it is fixed, for example is sealed with a sealing material. The walls 30b and the shells 32 thus serve as a housing of the laser scanner 10.

On the outer side of each of the two shells 32, a yoke 34 is arranged, which partially covers and thus protects the assigned shell 32. Each yoke 34 is fixed to the carrying structure 30, for example on the bottom of the traverse 30a. In an embodiment, each yoke 34 is made of aluminum and screwed to the traverse 30a at the side of the base 14. Each yoke 34 extends from its fixing point at the bottom of the traverse 30a obliquely to the next outer corner of the assigned shell 32, from where it extends along the outer edge of the shell 32 to the outer corner of the shell 32 which is above, on the upper side of the shell 32 obliquely up to the wall 30b, a short distance along it may be with an additional fixing point, and then mirror-symmetrically to the described course on the upper side of the shell 32, obliquely to the other outer corner, along the outer edge of the shell 32 to the outer corner of the shell 32 which is below and obliquely to the other fastening point at the bottom side of the traverse 30a.

The two yokes 34 together circumscribe a convex space, within which the two shells 32 are completely arranged, i.e., the two yokes 34 together project over all outer edges and outer surfaces of the shells 32. On top and on the bottom the oblique sections of the yokes 34 project over the top and/or bottom of the shells 32, on the four other sides, two sections each extending along an outer edge of the shells 32. The shells 32 are thus protected relatively extensively. Although each of the yokes 34 primarily has a protective function, particularly with respect to impacts which might damage the shells 32 and the components of the laser scanner 10 which are arranged below, further functions can be integrated in one or both of the yokes 34, for example a gripping possibility for carrying the laser scanner 10 and/or an illumination.

On top of the traverse 30a is provided a prism 36 which extends parallel to the walls 30b. In an embodiment, the prism 36 is an integrally formed (i.e., designed in one piece) component of the carrying structure 30, but a separate formation and fastening of the prism 36 to the traverse 30a is conceivable as well. When the mirror 16 rotates, it directs the emission light beam 18 onto the traverse, and more precisely onto the prism 36, once during each rotation, and moves the spot which is generated by the emission light beam 18 along the prism 36. Perpendicularly to the sense of movement of the spot of emission light beam 18, the profile of the prism 36 is designed such that, from the top of the traverse 30a, two trapezoids pointing downwards are designed, from which an isosceles triangle pointing upwards projects. Usually, the spot of the emission light beam 18 is so small that the spot hits the top of the triangle, but illuminates the sides only partially. The surface of the prism 36 is designed such that at least two different brightness levels and/or colors are provided along the direction of motion of the spot of emission light beam 18. For example, the half which is illuminated first can have a high brightness level (light grey, white), and the half which is illuminated next a low brightness level (dark grey, black). A reverse order or a striped pattern with several changes of the brightness level is possible as well.

Due to non-linearities in the electronic components, for example in the light receiver 21, the measured distances d depend on signal intensity, i.e., brightness, temperature and further parameters. A distance correction, which is stored as a function of brightness and is non linear, is therefore necessary. Since the prism 36 has a known distance d and known brightness levels, a correction of the distance correction can be performed by the prism 36, for example online, i.e., during operation the influence of temperature and other parameters can be compensated for. At the points corresponding to the brightness levels of the prism 36, the difference between the known distance and measured distance is determined. The correction of the distance correction is performed by adapting the curve of distance correction to the determined difference. This correction of distance correction may take place in the control and evaluation unit 22.

The traverse 30a has a receiving slot which is open at the bottom, and into which a swivel-axis module 40 is introduced. The swivel-axis module 40 is a pre-assembled assembly which comprises parts which are to be fixed at the carrying structure 30 and the base 14 which is rotatable in relation to the parts and parts which are fixed to it. The base 14 is provided with a dome 14a which protrudes upward. A sealing 41 is interposed between the dome 14a and the carrying structure 30. A swivel axis 42 which protrudes vertically upward is fixed to the dome 14a, for example, is screwed. A horizontally arranged worm gearing 44 is fixed to the swivel axis 42. The swivel axis 42 has an inner head 46 which, through use of a crossed roller bearing 47, bears an outer head 48. A horizontally arranged encoder disk 50 is fixed to the upper end of the inner head 46, above which the outer head 48 has encoder read heads 52. Slip rings 54 for the internal (i.e., which takes place within the swivel-axis module 40) transmission of data and energy of power supply are provided between the inner head 46 and the outer head 48. At the upper end of the outer head 48 and at the lower end of the base 14, electric plug connectors 55 for the transmission of data and energy from and to the measuring head 12 are provided.

For interaction with the worm gearing 44 a motor 56 with a planetary gear 57 is provided, which is borne in the carrying structure 30 and which drives a worm 58 which meshes with the worm gearing 44. The swivel-axis module 40 is introduced into the traverse 30a, so that the plug connectors 55 at the outer head 48 are plugged together with suitable counter-contacts, the worm 58 meshes with the worm gearing 44, the outer head 48 can be fixed to the carrying structure 30 and a sealing 59 lies between the base 14 and the carrying structure 30. In the swivel-axis module 40, the swivel axis 42, the worm gearing 44, the inner head 46 and the encoder disk 50 are fixed to the base 14, while, rotatably relative to this, the outer head 48 and the encoder read heads 52 are fixed to the carrying structure 30, and the motor 56 with the planetary gear 57 and the worm 58 are borne. The measuring head 12 is thus rotatable about a vertical axis, relative to the base 14.

The laser scanner 10 has an integrated cooling device 70 which cools by the air flowing through sealed ducts. The cooling device 70 comprises a suction duct 72 which may be designed with a rectangular profile, a fan 74 and an outlet duct 76 which may be designed with a rectangular profile. The fan 74 with its housing is connected to the suction duct 72 and to the outlet duct 76 in a sealed manner. The suction duct 72 is arranged between the motor 56 for the swiveling movement of the measuring head 12 and a motor for the rotation of the mirror 16 which is arranged above. The outlet duct 76 is arranged between the motor 56 and the electronics.

The suction duct 72 opens to a largely sealed space Z between the carrying structure 30 and the shell 32. The sealing of the space Z, with respect to the interior of the carrying structure 30, prevents intrusion of dirt and dust into the interior of the carrying structure. The carrying structure 30 has cooling fins 78 next to the motor 56, which transfer the heat from the interior of the carrying structure 30 into the space Z. From outside, the air gets over an air inlet 80, for example a ventilation grille with ribs, into the space Z. A filter, for example a filter mat, at the air inlet 80 prevents intrusion of coarse dust particles and dust into the space Z.

The outlet duct 76 terminates, sealed with respect to the space Z, at an air outlet 82, for example a ventilation grille with ribs. The air inlet 80 and the air outlet 82 are spaced apart from each other and, in an embodiment, are separated by the yoke 34 and configured on the bottom of the shell 32. The ribs of the ventilation grilles may be aligned such that the air flow to the air inlet 80 and from the air outlet 82 point away from one another, i.e., no heated-up air is sucked in. Additionally, a heat pipe extends between the area of the measuring head 12 with the control and evaluation unit 22 and the suction duct 72, the heat pipe transferring heat to the cooling device 70. The fan 74 sucks in air via the air inlet 80, the space Z and the suction duct 72 and blows the air again out of the laser scanner 10, via the outlet duct 76 and the air outlet 82. Cooling thus takes place.

The laser scanner 10 may have different sensors, for example a thermometer, inclinometer, altimeter, compass, gyroscopic compass, GPS, etc., which may be connected to the control and evaluation unit 22. Through use of these sensors the operating conditions of the laser scanner 10 are monitored, which are defined by certain parameters, for example geometric orientation or temperature. If one or several parameters have a drift, this is recognized by the corresponding sensors and can be compensated by the control and evaluation unit 22. Through use of these sensors, also a sudden change of operating conditions can be recognized, for example an impact on the laser scanner 10 which changes its orientation, or a displacement of the laser scanner 10. If the extent of the changes cannot be registered with sufficient precision, the scanning process should be interrupted or stopped. If the extent of the changes of operating conditions can be roughly estimated, the measuring head 12 can be turned back by some angular degrees until there is an overlapping with the area which has been scanned before the sudden change, and the scanning process continues. The two different parts of the scan can be assembled by an evaluation of the overlapping area.

1. A device for optically scanning and measuring an environment, comprising:
a laser scanner, having a light emitter—that emits an emission light beam and a light receiver that receives a reception light beam reflected from an object in the environment of the laser scanner; and
the laser scanner also having a with a control and evaluation unit which, for a multitude of measuring points, determines a distance to the object;
wherein a spot of the emission light beam temporarily moves along a prism of the laser scanner, the prism having at least two different brightness levels and/or colors.

2. The device according to claim 1, wherein the prism is configured at a traverse of a carrying structure of the laser scanner.

3. The device according to claim 1, wherein the prism is located perpendicular to a direction of motion of the spot of the emission light beam, the prism having a profile with two trapezoids between which a triangle projects.

4. The device according to claim 3, wherein the spot of the emission light beam illuminates a top of the triangle and at least a portion of sides of the triangle.

5. The device according to claim 1 wherein the different brightness levels and/or colors alternate along a direction of motion of the spot of the emission light beam.

6. The device according to claim 1, wherein the control and evaluation unit carries out a distance correction through use of the different brightness levels and/or colors and a known distance of the prism.

7. The device according to claim 6, wherein the control and evaluation unit corrects a distance correction which depends on the brightness levels.

8. The device according to claim 1, wherein the laser scanner further comprises a housing, wherein as part of the housing at least one shell is provided which partially is covered at its outer side by at least one yoke serving as protection.

9. The device according to claim 1, wherein the laser scanner further comprises a swivel-axis module which comprises a pre-assembled assembly and has a base which rests in a stationary reference system of the laser scanner and, the assembly also having parts which are fixed to a carrying structure of a measuring head which is rotatable relative to the base.

10. The device according to claim 1, wherein the laser scanner further comprises a cooling device with a space between a carrying structure and a shell which serves as a housing, the space being open at least partially to an outside of the laser scanner by an air inlet, and wherein a remainder of the space, is sealed with respect to the interior of the carrying structure and with respect to the shell.
